(19) United States
(12) Patent Application Publication
(10) Pub. No.: US 2010/0010737 A1
(43) Pub. Date: Jan. 14, 2010

(54) Position guiding method and apparatus for mobile communication terminal

(75) Inventor: Jong-Sun Pyo, Suwon-si (KR)

Correspondence Address: DOCKET CLERK, P.O. DRAWER 800889, DALLAS, TX, 75380, US

(73) Assignee: SAMSUNG ELECTRONICS CO., LTD., Suwon-si (KR)

(21) Appl. No.: 12/459,894

(22) Filed: Jul. 9, 2009

(30) Foreign Application Priority Data
Jul. 9, 2008 (KR) 10-2008-0066550

(51) Int. Cl. G01C 21/00

(52) U.S. Cl. 701/208

(57) ABSTRACT

A system and method and for guiding a mobile communication terminal. A position guiding system and method for a mobile communication terminal includes a position guiding apparatus configured to load map information of an area corresponding to a service cell that is selected from a plurality of cells divided to provide a mobile communication service and where the mobile communication terminal is positioned and the POI stored in correspondence to a cell ID of the service cell when a request to check the position of the mobile communication terminals is made. The position guiding apparatus displays the loaded map information and POI on a display unit.

### CROSS-REFERENCE TO RELATED APPLICATION(S) AND CLAIM OF PRIORITY

The present application is related to and claims the priority under 35 U.S.C. §119(a) of an application entitled “Position Guiding Method And Apparatus For Mobile Communication Terminal” filed in the Korean Industrial Property Office on Jul. 9, 2008 and assigned Serial No. 10-2008-0066550, the contents of which are hereby incorporated by reference.

### TECHNICAL FIELD OF THE INVENTION

The present invention relates to a method and an apparatus for guiding a position of a mobile communication terminal, and more particularly to a method and an apparatus for guiding a position of a mobile communication terminal including a Global Positioning System (GPS).

### BACKGROUND OF THE INVENTION

As mobile communication terminals and navigation terminals are generalized, GPS modules are also being commonly used in mobile communication terminals. A general position guiding process for a mobile communication terminal, to which a GPS module is mounted, is illustrated in FIG. 1.

FIG. 1 illustrates a flowchart for the position guiding process for a mobile communication terminal to which a GPS module is mounted. Referring to FIG. 1, if the user makes a request for the execution of navigation, the mobile communication terminal makes a request to check its position using a GPS in step 11. To achieve this, the current position of the mobile communication terminal is checked by operating a GPS receiver in step 13. After the current position of the mobile communication terminal is checked in step 13, a map database is searched using its current position and a map and a related Point of Interest (POI) for its current position is loaded in step 15. The step proceeds to step 21 in which the loaded map and POI are displayed on a screen. Meanwhile, if the user inputs a specific POI in step 17, the specific POI is searched for in a map tile for the current position of the mobile communication terminal in step 19, and the search result is displayed on the screen together with the loaded map and POI in step 21.

The specific POI may be input after a request for the execution of navigation is made in step 11, during step 15, or after the loaded map and POI are displayed on the screen. However, the specific POI input by the user is searched for after the map and the POI for the current position of the mobile communication terminal is loaded.

As described above, the specific POI input by the user is searched for after the map and POI for the current position of the mobile communication terminal is loaded regardless of the time point of the search request. In addition, the map and POI for the current position of the mobile communication terminal are loaded after the GPS receiver is operated to check its current position. That is, the search for the specific POI input by the user will be made after a time period for checking the current position of the mobile communication terminal through the GPS receiver and a time period for loading of the map and POI for its current position. The time periods consumed in the steps respectively are illustrated in FIG. 2.

In FIG. 2, a delay A is the time period for determining the position of the mobile communication terminal using the GPS and is generally five seconds to three minutes. Delay B is the time period for loading the map and POI for the current position of the mobile communication terminal and is generally one to two seconds. Finally, delay C is the time period for searching for the POI input by the user and comparing conditions and is generally one to two seconds.

In FIG. 2, since the steps are continuously performed without any overlapping section, a considerable time period is consumed to provide the map for the current position of the mobile communication terminal or the POI search result input by the user.

In particular, when a GPS signal cannot be received or the floating population around the current position of the user is large, the time period for searching for the initial GPS satellite becomes longer, thus increasing inconvenience to a user.

Meanwhile, a mobile communication system divides a service region to a plurality of cells and provides a base station for mobile communication in a map tile of each cell. Accordingly, the mobile communication terminal needs to inform a mobile communication terminal of the cell ID of the current cell and the cell ID of the adjacent cells.

### SUMMARY OF THE INVENTION

To address the above-discussed deficiencies of the prior art, it is a primary object to provide a method and apparatus that promptly provides an area where the user is currently positioned using a cell ID informed of by a mobile communication system.

The present invention also provides a method and apparatus that loads and provides POIs of corresponding areas without the calculation of the distances between the POIs using a result by which the area of the user can be immediately recognized.

The present invention further provides a method and apparatus that promptly provides a search result for a specific POI input by the user using a result by which the area of the user can be immediately recognized.

In accordance with an aspect of the present invention, there is provided a position guiding method for a mobile communication terminal. The method includes loading map information of an area corresponding to a service cell which is selected from a plurality of cells divided to provide a mobile communication service and where the mobile communication terminal is positioned and a POI stored in correspondence to a cell ID of the service cell when a request to check the position of the mobile communication terminals is made; and displaying the loaded map information and POI on a display unit.

The step of loading the map information and the POI includes the sub-step of loading the map information of an area corresponding to a cell proximate to the service cell and POIs stored in correspondence to cell IDs of the proximate cells.

The method further includes receiving a GPS signal and calculating the coordinate of the mobile communication terminal when the step of loading map information and a POI is performed; and displaying the coordinate of the mobile communication terminal on the map information displayed on the display unit after the coordinate of the mobile communication is calculated.

The method further includes the step of searching for a specific POI in the loaded POIs when a user makes a request to search for the specific POI.

The method further includes the step of searching for the specific POI in the POIs located in areas around the area corresponding to the service cell and the proximate cell when the specific POI does not exist in the loaded POIs.

The loaded map information and POI information is displayed on a standby screen when the mobile communication terminal is in an idle mode.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a flowchart for an existing position guiding process;

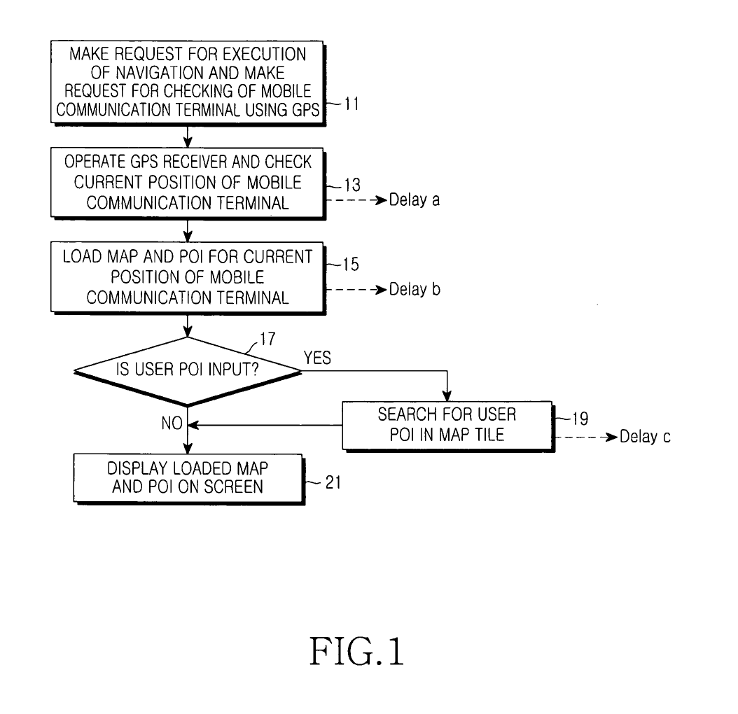

FIG. 2 illustrates a view of a position guiding time period in the position guiding process of FIG. 1;

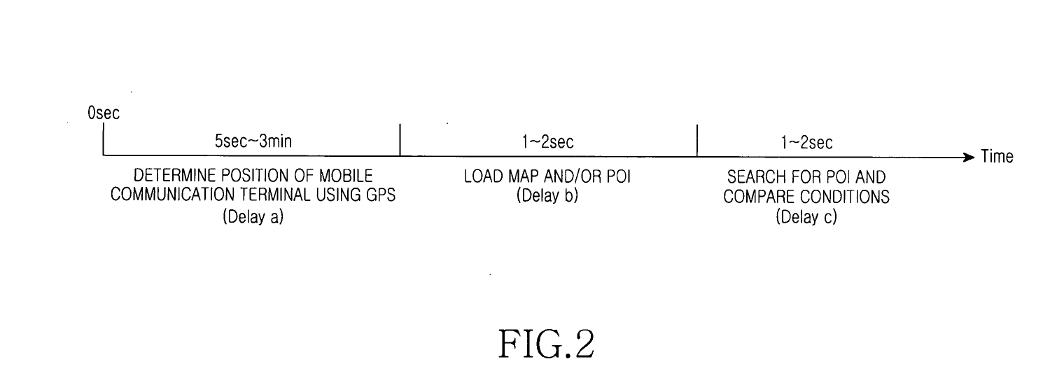

FIG. 3 illustrates a block diagram of a mobile communication terminal according to an embodiment of the present invention;

FIG. 4 illustrates a view of a configuration of cells and maps of a mobile communication service;

FIG. 5 illustrates a flowchart for a position guiding process according to an embodiment of the present invention;

FIG. 6 illustrates a view of a position guiding time period in the position guiding process of FIG. 5; and

FIG. 7 illustrates a view of a database format according to the embodiment of the present invention.

### DETAILED DESCRIPTION OF THE INVENTION

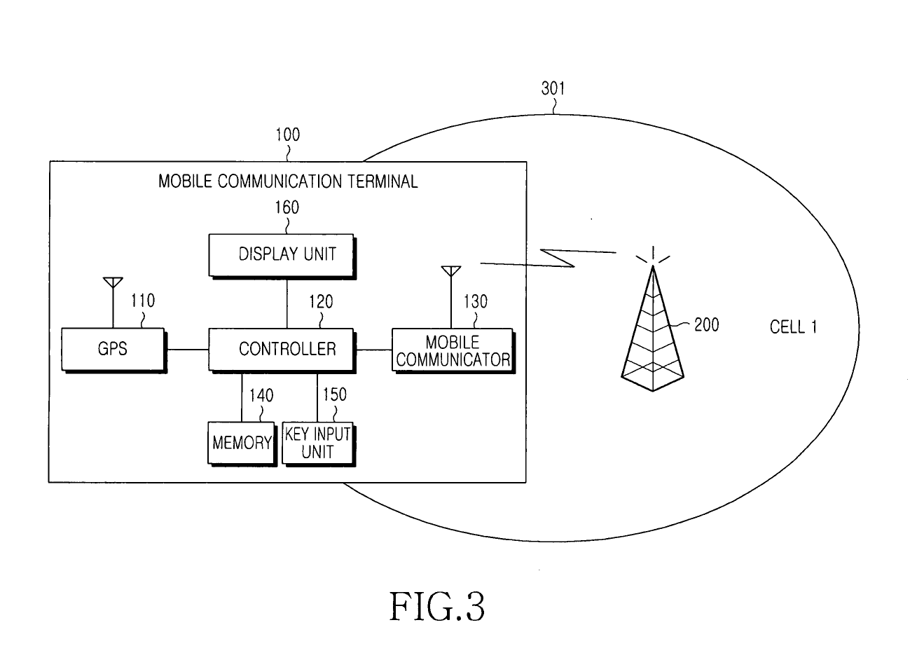

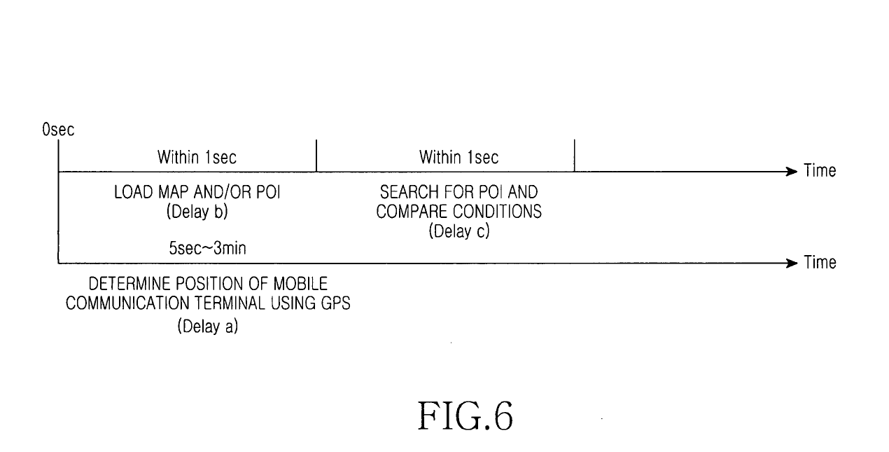

FIGS. 3 through 7, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged wireless communications network.

A mobile communication terminal to which the present invention is applied will be described with reference to FIG. 3. The mobile communication terminal 100 includes a GPS module 110, a controller, 120, a mobile communicator 130, a memory 140, a key input unit 150, and a display unit 160.

The controller 120 controls the overall operation of the mobile communication terminal 100.

The display unit 160 displays various image information and the data or images received from a base station 200 or stored in the memory 140 on a screen under the control of the controller 120.

The key input unit 150 includes a * key, a # key, and a plurality of function keys, such as MENU, SELECT, CALL, DELETE, POWER/END, VOLUME, PHOTO, and the like, which correspond to various functions of a mobile communication terminal, and provide key input data corresponding to the key pressed by the user to the controller 120. Numbers ‘0’ to ‘9’ are allocated to corresponding keys of the key input unit 150 and a plurality of Korean characters or English letters are allocated to the number keys to form letter keys.

The GPS module 110 receives a GPS signal under the control of the controller 120, calculates the current position of the mobile communication terminal in association with the controller 120 and the memory 140 using the received GPS signal, and obtains various data necessary for the execution of navigation.

The mobile communicator 130 performs a necessary operation and the processing of a signal necessary for mobile communication under the control of the control unit 120. The mobile communicator 130 transmits and receives a wireless signal with a base station 200 through an antenna. The mobile communicator 130 modulates a transmitted signal input from the controller 120 through a baseband processor to transmit a wireless signal through the antenna, and demodulates a wireless signal received through the antenna to provide the wireless signal to the controller 120 through the baseband processor. The baseband processor processes a baseband signal transmitted to and received from the controller 120. The mobile communicator 130 continuously changes the down/up links with the base station 200, and the link states are delivered to the controller 120 to control the states. The controller 120 contains information regarding a base station 200 connected to the mobile communicator 130, i.e., information regarding a base station of a service cell and information regarding an adjacent base station. The information means cell ID information corresponding to the ID of the base stations, and the cell ID of the service cell and the cell ID of the proximate cell are received by the base station of the service cell. In the embodiment of the present invention, a cell having a service area including the point where the mobile communication terminal 100 is currently positioned is referred to as the service cell.

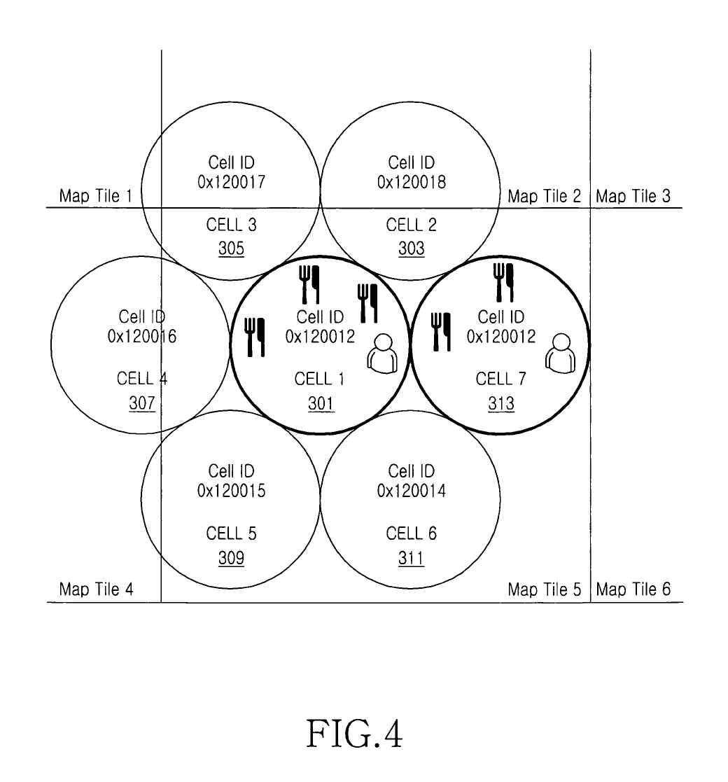

Such a cell ID is allocated as the cell planned result to regulate the local coverage in the mobile communication system, and is designed to support cities and an entire nation. In a service area of one cell, the communication radius of a base station is, for example, one (1) to two (2) kilometers (km) in the downtown of a city or 3 to 5 km in the outskirts of the city. Accordingly, as illustrated in FIG. 4, a plurality of cells may exist in a map tile of a map divided for the execution of navigation, and thus several different cell IDs may exist together. In addition, in one map tile, a plurality of POIs may exist in one cell. Referring to FIGS. 3 and 4, the user, i.e., the mobile communication terminal 100 is positioned in cell_1 200 and cell_1 301 is included in map tile 5. Cell_2 303, cell_3 305, cell_4 307, cell_5 309, cell_6 311, and cell_7 313 are proximate to cell_1 301, and the entire area or part of the cell is included in the map tile_5.

Accordingly, the present invention basically utilizes the cell ID of the service cell where the mobile communication terminal 100 is currently positioned, and additionally utilizes the cell IDs of the proximate cells.

The memory 140 stores programs for processing and controlling the operation of the controller 120, reference data, renewable keeping data, and the like, and provides the programs and data to a wording memory of the controller 120. The memory 140 contains a map/POI database for provision of navigation.

In the embodiment of the present invention, the map/POI database stores the cell IDs of the cells including the points where the POIs are positioned in correspondence to the POIs and contains position information of the cells in the map. The position information of the cells can be accessed and managed through the cell IDs. The memory 140 stores information regarding the correlation between the cells.

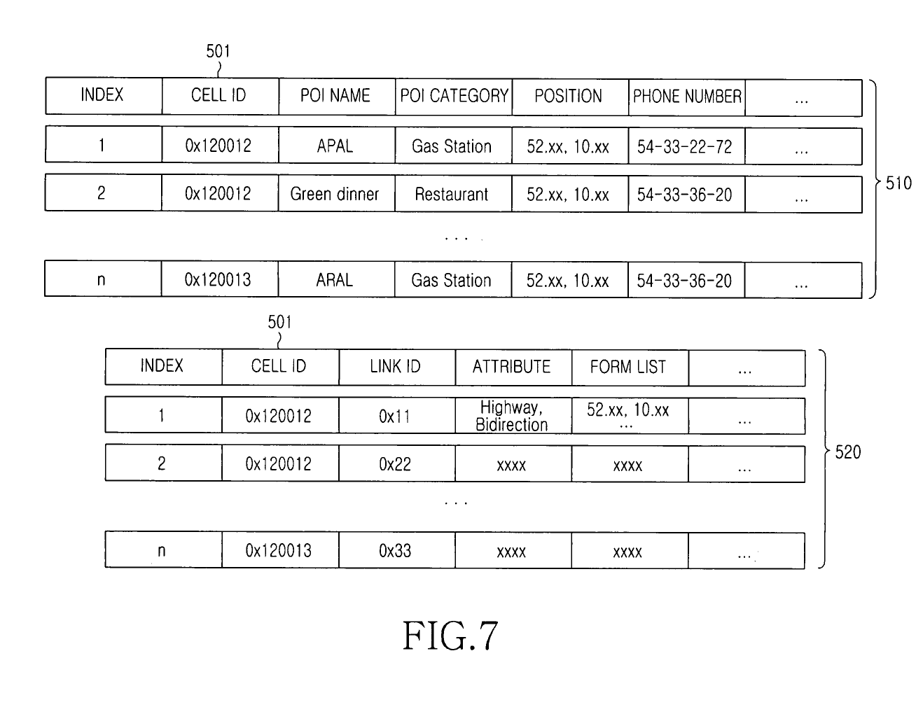

FIG. 7 illustrates a format forming the POI database. Referring to FIG. 7, the map/POI database format 510 contains a cell ID field 501 as well as an index field, a POI name field, a POI category field, a position field, and a phone number field. The cell IDs may be stored in the map/POI database in correspondence to objects displayed on a map during the execution of navigation. As an example, a map database format 520 regarding road line information can be referred to in FIG. 7.

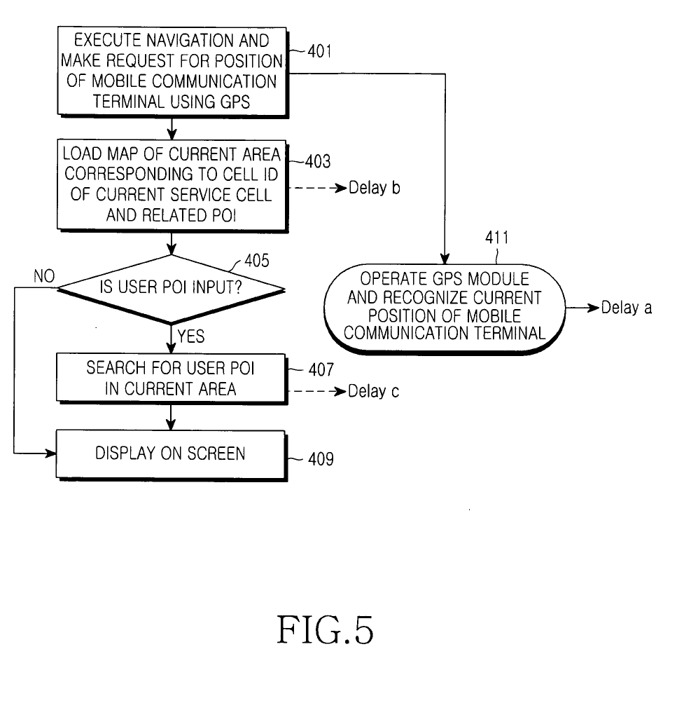

The process of guiding a position by the mobile communication terminal 100 is illustrated in FIG. 5. Referring to FIG. 5, if the user makes a request for execution of navigation, the controller 120 confirms that a request for checking the position is made. The request for checking the position may be made in correspondence to a request for the execution of navigation, or may be made when a function of the mobile communication terminal requiring position information is performed. If the controller 120 detects a request to check the position, the coordinate of the mobile communication terminal 100 is calculated using the GPS in step 411, and an area within a predetermined range of where the mobile communication terminal 100 is positioned, i.e., the current area of the mobile communication terminal 100 is checked using the cell ID of the service cell in step 403.

For example, in step 411, the controller 120 operates the GPS module 110 in order to recognize the current point of the mobile communication terminal 100 and its peripheral areas to process a signal and perform a calculation process. The controller 120 searches the map/POI database using the cell ID of the service cell in step 403 in parallel to step 411, and loads the map of the area corresponding to the cell ID and the POI in the area.

Then, the controller 120 can recognize the cell IDs of the cells proximate to the service cell, i.e., the proximate cells and load the maps of the areas corresponding to the proximate cells and the related POIs together. In this case, the number of the proximate cells becomes different according to the cell mapping of the mobile communication system and the area corresponding to the service cell and the proximate cells are recognized as the current area. Referring to FIG. 4, since the mobile communication terminal 100 is located in cell_1 301, the controller 120 loads the map of the area corresponding to cell_1 301 using cell ID ‘0x120012’ and the POI in the area, or loads the maps of the areas corresponding to the proximate cells and the related POIs using the cell IDs of the proximate cells, i.e., cell_2 303, cell_3 305, cell_4 307, cell_5 309, cell_6 311, and cell_7 313.

In this way, although the accurate position of the mobile communication terminal 100 cannot be recognized by detecting the area where the mobile communication terminal is positioned with reference to the service cell of the mobile communication terminal, a specific area including the point where the mobile communication terminal 100 is positioned and its related information can be promptly recognized. The time period for extracting the map of the current area and the POIs in the peripheral areas is shortened.

Thereafter, if the user does not make a request to search for a specific POI, the controller 120 displays the map of the current area and the related POIs loaded in step 413 on a screen in step 409. If the user makes a request to search for a specific POI, the map of the current area and the related POIs loaded in step 403 is searched for and the result is displayed on the screen in step 409. In this case, since the search object to search for the specific POI is reduced to the POI in the current area, the time period for the search can be shortened. If the coordinate of the mobile communication terminal 100 is calculated in step 411, the controller 120 reflects the result on the loading result of step 403 to display the reflection result.

The present invention allows the user to recognize the current area in a short time using the cell ID of a service cell for the mobile communication terminal 120 to provide information related to it or provide the search result about a specific POI input by the user in a state in which the position of the mobile communication terminal 120 cannot be recognized using a GPS signal or has not been recognized.

The time periods consumed in the steps will be described with reference to FIG. 5. When the time period consumed for determining the position of the mobile communication terminal using a GPS signal is referred to as delay A, the time period consumed for loading the map for the current area and the related POI is referred to as delay B, and the time period consumed searching for a specific POI input by the user is referred to as delay C, since delay B and delay C are sequential but the delay a is parallel to delay B or delay C, the final search time period can be shortened. The position of the mobile communication terminal 100 using a GPS signal may not be calculated according to the function performed by the mobile communication terminal.

According to another embodiment of the present invention, the map and POI information for the current area recognized only by performing step 403 and step 409 in FIG. 5 may be displayed on a screen in an idle mode of the mobile communication terminal, i.e., a standby screen. Then, the current area displayed on the standby screen may be limited to an area corresponding to a service cell. In this case, if the mobile communication terminal is handed over to a proximate cell, the displayed map and POI information may become different. Accordingly, the user can be informed of the area where the user is positioned in real time.

The function of recognizing the area where the mobile communication terminal is positioned can be associated with a position based service using the cell IDs of a service cell or the cells proximate to the service cell, thus shortening the position function service providing time period. For example, if the position based service for generating an alarm and if the mobile communication terminal is positioned in an area is set within the predetermined range, the mobile communication terminal 100 can recognize the current area using the above-described processes to generate an alarm.

Although the detailed embodiments of the present invention are described, various modifications may be made without departing from the scope of the present invention. For example, a specific POI is searched for within a POI located in the current area, and if the specific POI cannot be searched for, the POIs located in the peripheral area may be searched for. In other words, a specific POI is searched for first in the current area, the searched areas are gradually expanded to the peripheral areas. Since the POIs are stored together with the corresponding position coordinates, the POIs of the peripheral areas may be simply recognized through the comparison between the POI of the current area and the position coordinates. The geographical sizes of the expanded peripheral areas may be determined in advance.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A method for guiding a position of a mobile communication terminal, the method comprising:
loading map information and a Point of Interest (POI), the map information is of an area corresponding to a service cell that is selected from a plurality of cells divided to provide a mobile communication service and where the mobile communication terminal is positioned and the POI is stored in correspondence to a cell ID of the service cell when a request to check the position of the mobile communication terminals is made; and
displaying the loaded map information and POI on a display unit.

2. The method according to claim 1, wherein loading the map information and the POI comprises loading the map information of an area corresponding to a cell proximate to the service cell.

3. The method according to claim 2, wherein loading the map and the POI comprises loading POIs stored in correspondence to cell IDs of the proximate cells.

4. The method according to claim 3, further comprising the steps of:
receiving a GPS signal and calculating the coordinate of the mobile communication terminal when the loading map information and a POI is performed; and
displaying the coordinate of the mobile communication terminal on the map information displayed on the display unit after the coordinate of the mobile communication is calculated.

5. The method according to claim 4, further comprising searching for a specific POI in the loaded POIs when a user makes a request to search for the specific POI.

6. The method according to claim 4, further comprising searching for the specific POI in the POIs located in areas around the area corresponding to the service cell and the proximate cell when the specific POI does not exist in the loaded POIs.

7. The method according to claim 2, wherein the loaded map information and POI information is displayed on a standby screen when the mobile communication terminal is in an idle mode.

8. An apparatus for guiding a position of a mobile communication terminal, the apparatus comprising:
a memory configured to store at least one of a map and Point of Interest (POI) in a database for navigation, the memory further configured to store cell ID of at least one of cells including the point where the at least one of POIs is positioned in correspondence to the POIs and where a POI is located in correspondence to the cell ID, and the memory further configured to store position information of the cell in the map; and
a controller configured to load map information of an area corresponding to the service cell where the mobile communication terminals currently is positioned and the POI stored in correspondence to the cell ID of the service cell when a request to check of the position of the mobile communication terminals is made, the controller further configured to display the loaded map information and POI on a display unit.

9. The apparatus according to claim 8, wherein the controller loads map information of an area corresponding to a cell proximate to the service cell.

10. The apparatus according to claim 9, wherein the controller loads the POI stored in correspondence to cell IDs of the proximate cells.

11. The apparatus according to claim 10, further comprising a GPS module receiving a GPS signal and calculating the coordinate of the mobile communication terminal using the received GPS signal, wherein the controller controls the GPS module to calculate the position coordinate of the mobile communication terminal when loading the map information and the POI.

12. The apparatus according to claim 11, wherein the loaded map information and POI information is displayed on a standby screen when the mobile communication terminal is in an idle mode.

13. The apparatus according to claim 11, wherein the controller searches for a specific POI in the loaded POIs when a user makes a request for search for the specific POI.

14. The apparatus according to claim 13, wherein the controller searches for the specific POI in the POIs located in areas around the area corresponding to the service cell and the proximate cell when the specific POI does not exist in the loaded POIs.

15. A mobile communications terminal for communicating in a wireless communications network, the mobile communications terminal comprising a position guiding apparatus, the position guiding apparatus comprising:
a memory configured to store at least one of a map and Point of Interest (POI) in a database for navigation, the memory further configured to store a cell ID of a cell that is selected from a plurality of cells divided to provide a mobile communication service and where a POI is located in correspondence to the cell ID, and the memory further configured to store position information of the cell in the map; and
a controller configured to load map information of an area corresponding to the service cell where the mobile communication terminals currently is positioned and the POI stored in correspondence to the cell ID of the service cell when a request to check of the position of the mobile communication terminals is made, the controller further configured to display the loaded map information and POI on a display unit.

16. The mobile communications terminal according to claim 15, wherein the controller loads map information of an area corresponding to a cell proximate to the service cell and loads the POI stored in correspondence to cell IDs of the proximate cells.

17. The mobile communications terminal according to claim 16, further comprising a GPS module receiving a GPS signal and calculating the coordinate of the mobile communication terminal using the received GPS signal, wherein the controller controls the GPS module to calculate the position coordinate of the mobile communication terminal when loading the map information and the POI.

18. The mobile communications terminal according to claim 17, wherein the loaded map information and POI information is displayed on a standby screen when the mobile communication terminal is in an idle mode

19. The mobile communications terminal according to claim 16, wherein the controller searches for a specific POI in the loaded POIs when a user makes a request for search for the specific POI.

20. The mobile communications terminal according to claim 19, wherein the controller searches for the specific POI in the POIs located in areas around the area corresponding to the service cell and the proximate cell when the specific POI does not exist in the loaded POIs.
